(19) United States
(12) Patent Application Publication
(10) Pub. No.: US 2019/0084606 A1
(43) Pub. Date: Mar. 21, 2019

(54) climate controlled stroller

(71) Applicant: Eric Acheampong, St. Albans, NY (US)

(72) Inventor: Eric Acheampong, St. Albans, NY (US)

(21) Appl. No.: 15/414,971

(22) Filed: Jan. 25, 2017

(51) Int. Cl. B62B 9/14; B62B 9/12; B62B 7/04; B62B 9/20; B60R 16/04

(52) U.S. Cl. CPC B62B 9/14; B62B 9/12; B60R 16/04; B62B 9/20; B62B 7/04

(57) ABSTRACT

A climate controlled stroller that adjusts its temperature during the summer and winter. The climate controlled stroller includes a cooling system adapted to inject cool air into the foldable housing to cool within the foldable housing, the cooling system includes a plurality of temperature controls incorporated into the stroller handle adapted to adjust the temperature inside the foldable housing and a plurality of pipes built-into the foldable housing adapted to be controlled by the temperature controls that are adapted to change the temperature within the foldable housing climate controlled stroller.

### BACKGROUND OF THE INVENTION

### Field of the Invention

The present invention is a stroller. More specifically, the present invention is a climate controlled stroller.

### Description of the Related Art

It is vital for mothers to ensure the comfort of their young children when going out, as they do not want their child to cry out in discomfort when they feel too hot or too cold. Presently, products available on the market are available with a sun and/or wind shield but do not regulate the temperature inside of the stroller.

What is needed is a climate controlled stroller that adjusts its temperature during the summer and winter from inside the stroller.

### SUMMARY OF THE INVENTION

The present invention is a stroller. More specifically, the present invention is a climate controlled stroller.

The climate controlled stroller includes a foldable housing containing an infant that is being transported within the stroller, the foldable housing includes a foldable top that is attached to a top portion of the foldable housing, a stroller handle attached to the foldable housing that extends upward and outward from the foldable housing, the stroller handle is grasped and adapted to transport the climate controlled stroller along a surface and a cooling system adapted to inject cool air into the foldable housing to cool within the foldable housing, the cooling system includes a plurality of temperature controls incorporated into the stroller handle adapted to adjust the temperature inside the foldable housing. The climate controlled stroller also includes a heated seat adapted to warm an infant or other suitable person contained within the foldable housing, a plurality of wheels extending from a bottom portion of the foldable housing with a plurality of wheel frames and a rechargeable battery positioned underneath the foldable housing and adapted to provide electrical power to the cooling system and the heated seat.

It is an object of the present invention to provide a climate controlled stroller that features a heating and cooling regulator embedded into the seat of the stroller which ensures optimal comfort.

It is an object of the present invention to provide a climate controlled stroller that is designed to be manufacture with a rechargeable battery and easy fold capabilities for effortless transport.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a climate controlled stroller, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

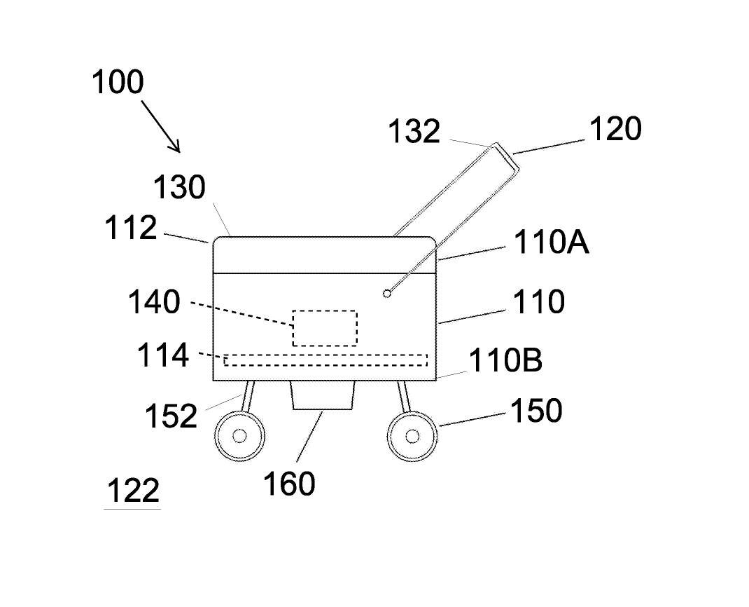

FIG. 1 illustrates a climate controlled stroller 100, in accordance with one embodiment of the present invention.

The climate controlled stroller 100 may include a foldable housing 110, a stroller handle 120, a cooling system 130, a heated seat 140, a plurality of wheels 150 and a rechargeable battery 160.

The foldable housing 110 may contain an infant (not shown) that is being transported within the stroller. The foldable housing 110 may include a foldable top 112 that may be attached to a top portion 110A of the foldable housing 110. The foldable top 112 may be adapted to cover or expose the top portion 110A of the foldable housing 110. The foldable top 112 may also be removed. The stroller handle 120 may be attached to the foldable housing 110 and may extend upward and outward from the foldable housing 110. The stroller handle 120 may be grasped and adapted to transport the climate controlled stroller 100 along a surface 122. The stroller handle 120 may be tilted at approximately forty-five degrees to provide an ideal angle to grasp and push the climate controlled stroller 100. The cooling system 130 may be adapted to inject cool air into the foldable housing 110 to cool an infant or other suitable person contained within the foldable housing 110. The cooling system 130 may include a plurality of temperature controls 132 incorporated into the stroller handle 120 adapted to adjust the temperature inside the foldable housing 110. A plurality of pipes 114 may be built-into the foldable housing 110 that may be adapted to be controlled by the temperature controls 132 that are adapted to change the temperature within the foldable housing 110. The cooling system 130 may be a small air-conditioner unit (not shown), a small forced air cooler (not shown) or other suitable cooling system. The heated seat 140 may be adapted to warm an infant or other suitable person contained within the foldable housing 110. The wheels 150 may extend from a bottom portion 1108 of the foldable housing 110 with a plurality of wheel frames 152. The rechargeable battery 160 may be positioned underneath the foldable housing 110 and may be adapted to provide electrical power to the cooling system 130 and the heated seat 140. The rechargeable battery 160 may be selected from the group consisting of a lead-acid battery, a nickel cadmium battery or NiCd battery, a nickel metal hydride or NiMH battery, a lithium ion or Li-ion battery or a lithium ion polymer or Li-ion battery.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention

1. A climate controlled stroller, comprising:
a foldable housing containing an infant that is being transported within the stroller, the foldable housing includes a foldable top that is attached to a top portion of the foldable housing;
a stroller handle attached to the foldable housing that extends upward and outward from the foldable housing, the stroller handle is grasped and adapted to transport the climate controlled stroller along a surface;
a cooling system adapted to inject cool air into the foldable housing to cool within the foldable housing, the cooling system includes a plurality of temperature controls incorporated into the stroller handle adapted to adjust the temperature inside the foldable housing;
a heated seat adapted to warm an infant or other suitable person contained within the foldable housing;
a plurality of wheels extending from a bottom portion of the foldable housing with a plurality of wheel frames; and
a rechargeable battery positioned underneath the foldable housing and adapted to provide electrical power to the cooling system and the heated seat.

2. The climate controlled stroller according to claim 1, wherein the foldable top is removable.

3. The climate controlled stroller according to claim 1, wherein the stroller handle is tilted at forty-five degrees to provide an angle to grasp and push the climate controlled stroller.

4. The climate controlled stroller according to claim 1, further comprising a plurality of pipes built-into the foldable housing adapted to be controlled by the temperature controls that are adapted to change the temperature within the foldable housing climate controlled stroller.

5. The climate controlled stroller according to claim 1, wherein the rechargeable battery is selected from the group consisting of a lead-acid battery, a nickel cadmium battery, a nickel metal hydride battery, a lithium ion battery or a lithium ion polymer battery.
